(19) United States
(12) Patent Application Publication
(10) Pub. No.: US 2026/0162921 A1
(43) Pub. Date: Jun. 11, 2026

(54) HANDHELD TOOL FOR FUSE ASSEMBLY

(71) Applicant: Caterpillar Inc., Peoria, IL (US)

(72) Inventors: C. Brahm Landis, Indianapolis, IN (US); Timothy Beetler, Princeville, IL (US); Alan E. West, Peoria, IL (US)

(73) Assignee: Caterpillar Inc., Peoria, IL (US)

(21) Appl. No.: 18/973,668

(22) Filed: Dec. 9, 2024

(51) Int. Cl. H01H 85/02

(52) U.S. Cl. CPC H01H 85/0208

(57) ABSTRACT

A handheld tool for a fuse assembly includes a body. The body includes a central portion defining a first end and a second end. The body also includes a first portion defining a first through-opening. The first portion includes a first bottom surface and a pair of first projections. The pair of first projections define a first space that is aligned with the first through-opening. The body further includes a second portion defining a second through-opening. The second portion includes a second bottom surface and a pair of second projections. The pair of second projections define a second space that is aligned with the second through-opening. Each of the central portion, the first portion, and the second portion together define a top surface and a cavity that receives a portion of the fuse assembly. The handheld tool also includes a handle coupled with the body at the top surface.

### TECHNICAL FIELD

The present disclosure relates to a handheld tool for a fuse assembly and a method of at least one of removing and installing the fuse assembly in a power module.

### BACKGROUND

A power module is often used to supply an electric power supply to a number of systems, such as those associated with a work machine, a construction site, or a mining site. The power module typically includes a fuse assembly to prevent damage to one or more high voltage components associated with the power module. The fuse assembly may be removably coupled with the power module via one or more fastening devices, such as washers, fasteners, and the like. Such fastening devices are small and difficult to handle and assemble while wearing a high-voltage protective equipment (HV PPE).

Generally, the fuse assembly is removed and/or installed within the power module by an assembly personnel. The assembly personnel are required to wear special protective gear like the HV PPE. During removal or installation of the fuse assembly, the assembly personnel may inadvertently drop the fastening devices within the power module. It may be cumbersome and unergonomic for the assembly personnel to locate and pick the fastening devices while wearing the HV PPE, which may increase an assembly time, may cause fatigue to the assembly personnel, and may increase a downtime of the power module. Moreover, as the fastening devices are small in size, it may be challenging for the assembly personnel to handle the fastening devices during removal or installation, which may in turn increase the assembly time and efforts.

KR20130021839 describes a fuse array jig of a battery protection circuit to improve work efficiency for mounting a fuse on a printed circuit board and to reduce failure. Constitution: a fuse array jig of a battery protection circuit comprises a jig main body with fuse mounting grooves which are aligned in a line and spaced apart at regular intervals in the width direction; and a lifting operation part with a lifting rod extending along the width direction of the jig main body in order to lift and attach the fuse to a PCB substrate. The jig main body has a rod acceptance groove accepting the lifting rod in the jig main body. The fuse mounting grooves are vertically formed across the width of the jig main body.

### SUMMARY OF THE DISCLOSURE

In an aspect of the present disclosure, a handheld tool for a fuse assembly is provided. The handheld tool includes a body extending along each of a longitudinal axis, a lateral axis, and a transverse axis. The body includes a central portion defining a first end and a second end opposite the first end. The body also includes a first portion integral with the central portion and extending from the first end of the central portion along the longitudinal axis of the body. The first portion defines a first through-opening. The first portion includes a first bottom surface and a pair of first projections extending from the first bottom surface of the first portion along the transverse axis of the body. The pair of first projections are spaced apart from each other along the lateral axis of the body. The pair of first projections define a first space that is in alignment with the first through-opening. The body further includes a second portion integral with the central portion and extending from the second end of the central portion along the longitudinal axis of the body. The second portion defines a second through-opening. The second portion includes a second bottom surface and a pair of second projections extending from the second bottom surface of the second portion along the transverse axis of the body. The pair of second projections are spaced apart from each other along the lateral axis of the body. The pair of second projections define a second space that is in alignment with the second through-opening. Each of the central portion, the first portion, and the second portion together define a top surface of the body and a cavity of the body that is adapted to receive a portion of the fuse assembly therein to at least one of remove and install the fuse assembly from a power module. The handheld tool also includes a handle coupled with the body at the top surface thereof.

In another aspect of the present disclosure, a method of at least one of removing and installing a fuse assembly in a power module is provided. The method includes coupling, removably, the fuse assembly with a handheld tool. The handheld tool includes a body extending along each of a longitudinal axis, a lateral axis, and a transverse axis. The body includes a central portion defining a first end and a second end opposite the first end. The body also includes a first portion integral with the central portion and extending from the first end of the central portion along the longitudinal axis of the body. The first portion defines a first through-opening. The first portion includes a first bottom surface and a pair of first projections extending from the first bottom surface of the first portion along the transverse axis of the body. The pair of first projections are spaced apart from each other along the lateral axis of the body. The pair of first projections define a first space that is in alignment with the first through-opening. The body further includes a second portion integral with the central portion and extending from the second end of the central portion along the longitudinal axis of the body. The second portion defines a second through-opening. The second portion includes a second bottom surface and a pair of second projections extending from the second bottom surface of the second portion along the transverse axis of the body. The pair of second projections are spaced apart from each other along the lateral axis of the body. The pair of second projections define a second space that is in alignment with the second through-opening. Each of the central portion, the first portion, and the second portion together define a top surface of the body and a cavity of the body. The handheld tool also includes a handle coupled with the body at the top surface thereof. The method also includes receiving a portion of the fuse assembly within the cavity of the body based on the coupling of the fuse assembly with the handheld tool. The method further includes carrying, using the handle of the handheld tool, the handheld tool and the fuse assembly to a desired location. The desired location includes a location within the power module or a workstation. The method includes positioning the handheld tool at the desired location. The method also includes disassembling the fuse assembly from the handheld tool to at least one of remove and install the fuse assembly.

Other features and aspects of this disclosure will be apparent from the following description and the accompanying drawings.

### BRIEF DESCRIPTION OF THE DRAWINGS

FIG. 1 is a perspective view of a power module including a fuse assembly, according to an example of the present disclosure;

FIG. 2 is a schematic left perspective view illustrating the fuse assembly of FIG. 1 coupled with a handheld tool, according to an example of the present disclosure;

FIG. 3 is a schematic right perspective view illustrating the fuse assembly of FIG. 2 coupled with the handheld tool;

FIG. 4 is a schematic perspective view of the handheld tool for the fuse assembly of FIG. 2 without the fuse assembly;

FIG. 5 is a schematic bottom perspective view of the handheld tool of FIG. 2; and

FIG. 6 is a flowchart for a method of at least one of removing and installing the fuse assembly in the power module of FIG. 1, according to an example of the present disclosure.

### DETAILED DESCRIPTION

Wherever possible, the same reference numbers will be used throughout the drawings to refer to the same or like parts.

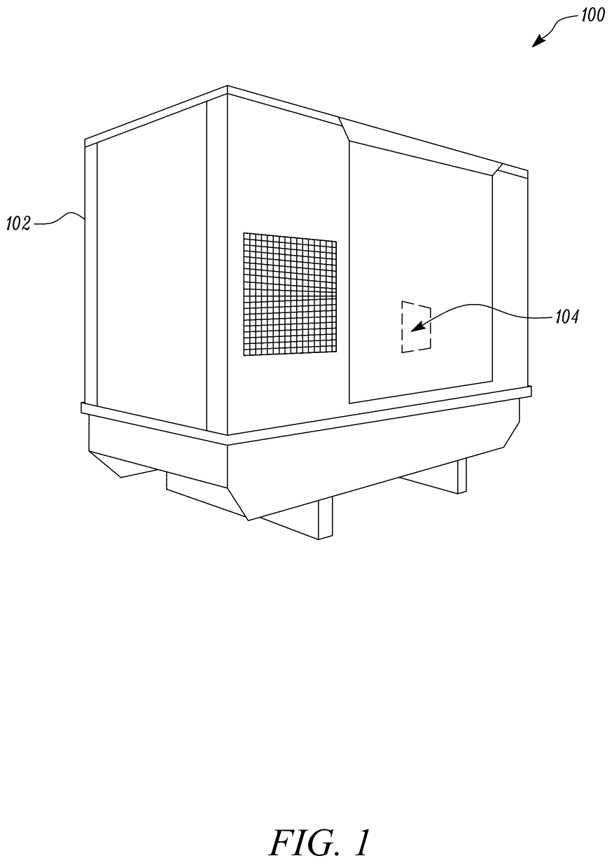

Referring to FIG. 1, a perspective view of a power module 100 is illustrated. The power module 100 is an electrical power source used for supplying electrical power. The power module 100 may provide electrical power to a work machine, or to equipment at a worksite, such as a construction site, a mining site, and the like. The power module 100 may be a containerized power module. In some examples, the power module 100 may be used as an external load. In other examples, the power module 100 may be embodied as an internal power source of a work machine. The power module 100 may be a portable electrical power source and may be equipped with handles, wheels, or built-in trolleys for easy mobility. In an example, the power module 100 may be a genset that stores and supplies the electrical energy. It should be noted that the present disclosure is not limited to a type of the power module.

The power module 100 includes an enclosure 102. The enclosure 102 encloses one or more components (not shown herein) of the power module 100. In an example, the enclosure 102 of the power module 100 may enclose an uninterruptible power supply (UPS) unit, one or more sensors, one or more inverters, one or more converters, and the like of the power module 100. In some examples, the enclosure 102 may include a door (not shown) to provide access for a personnel to inspect, replace, or remove components of the power module 100.

The power module 100 includes a fuse assembly 104. The fuse assembly 104 is removably coupled with the power module 100. The fuse assembly 104 may be used as an overcurrent protection device in the power module 100. In other words, the fuse assembly 104 may act as a device that operates to provide protection against an overflow of current in an electrical circuit inside the power module 100.

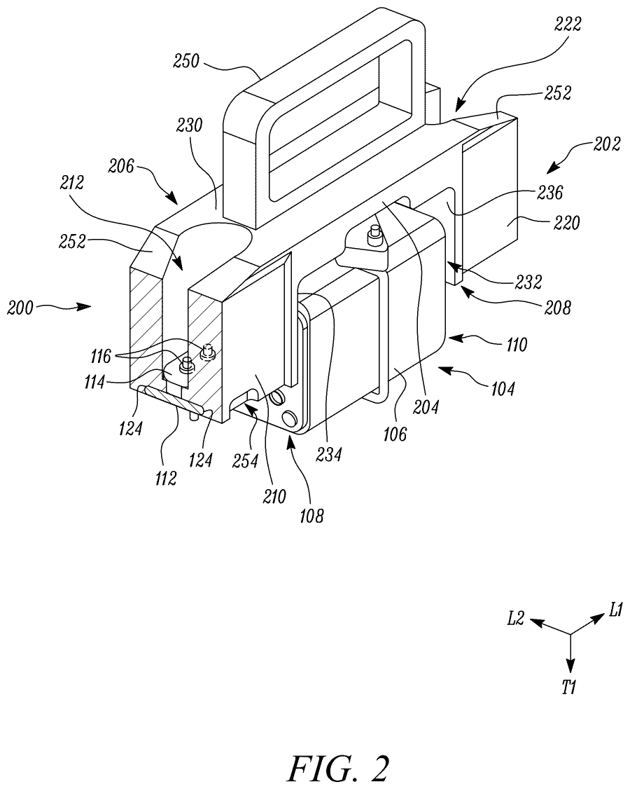

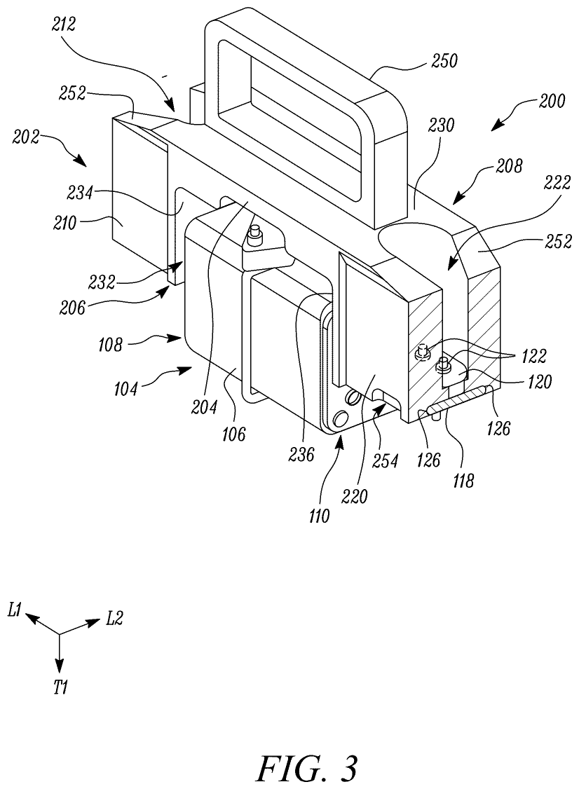

Referring to FIGS. 2 and 3, the fuse assembly 104 includes a housing 106. The housing 106 may hold and support various components (not shown) of the fuse assembly 104 that may protect the power module 100 from current surges and overloads.

The fuse assembly 104 also includes a first busbar 112. The first busbar 112 extends from one end 108 of the housing 106. The fuse assembly 104 also includes a first washer 114. The first washer 114 is coupled with the first busbar 112. The fuse assembly 104 also includes a pair of first fasteners 116. The pair of first fasteners 116 of the fuse assembly 104 are coupled with the first washer 114 and the first busbar 112. Alternatively, the fuse assembly 104 may include any number of first fasteners 116 based on application attributes. The pair of first fasteners 116 are embodied as bolts herein.

The fuse assembly 104 further includes a second busbar 118. The second busbar 118 extends from an opposing end 110 of the housing 106. The first busbar 112 and the second busbar 118 are similar to each other in terms of design. The first busbar 112 and the second busbar 118 have a rectangular shape. Further, each of the first busbar 112 and the second busbar 118 include a pair of rounded outer surfaces 124, 126.

The fuse assembly 104 includes a second washer 120. The second washer 120 is coupled with the second busbar 118. The first washer 114 and the second washer 120 are similar to each other in terms of design. The first washer 114 and the second washer 120 are elliptical in shape.

The fuse assembly 104 also includes a pair of second fasteners 122. The pair of second fasteners 122 of the fuse assembly 104 are coupled with the second washer 120 and the second busbar 118. Alternatively, the fuse assembly 104 may include any number of second fasteners 122 based on application attributes. The pair of second fasteners 122 are embodied as bolts herein.

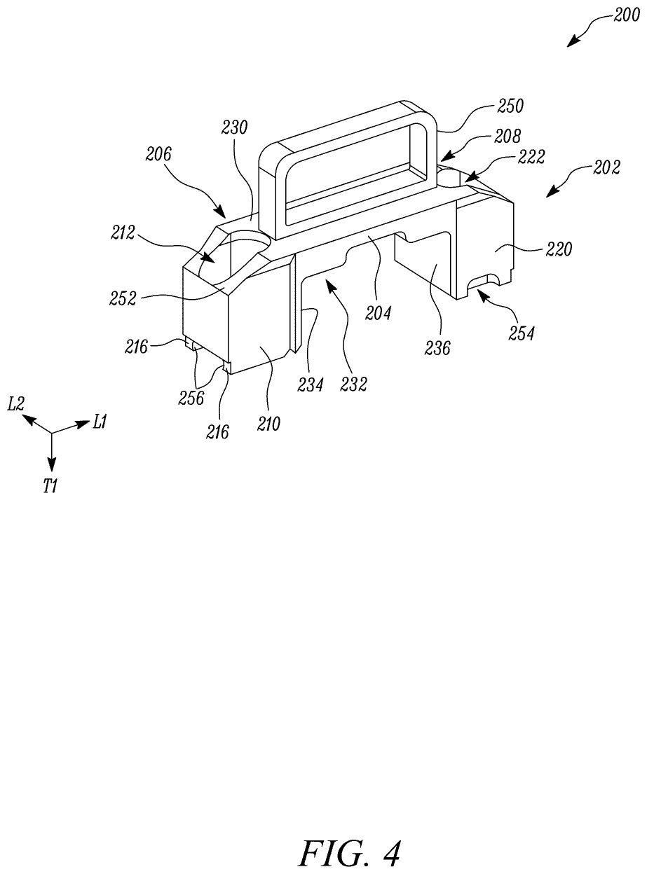

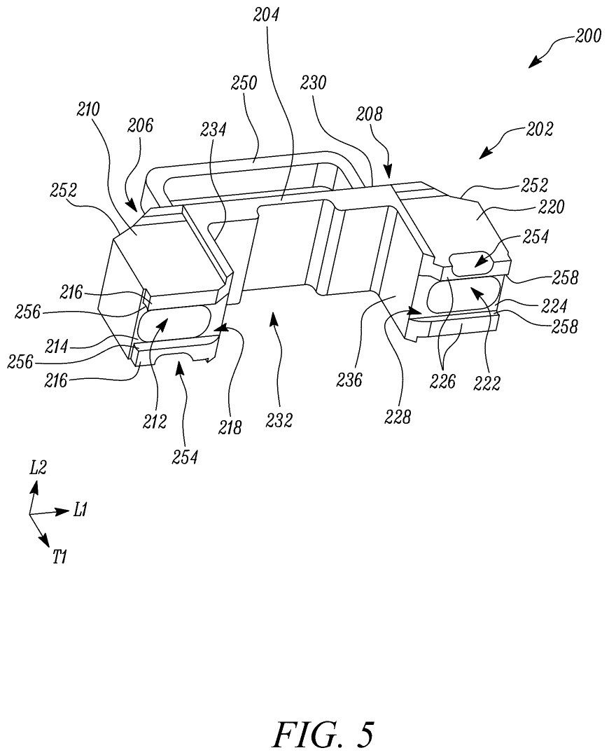

FIG. 4 is a schematic perspective view of a handheld tool 200 for the fuse assembly 104 of FIG. 2. FIG. 5 is a schematic bottom perspective view of the handheld tool 200. With reference to FIGS. 4 and 5, the handheld tool 200 includes a body 202 extending along each of a longitudinal axis L1, a lateral axis L2, and a transverse axis T1. The body 202 includes one or more features 252, 254 to allow positioning of the handheld tool 200 within the power module 100 (see FIG. 1) or removal of the handheld tool 200 from the power module 100. The one or more features 252, 254 may include a chamfer 252 and/or a notch 254. Specifically, in the illustrated example of FIGS. 4 and 5, the feature 252 is a chamfer 252 and the feature 254 is a notch 254. The body 202 includes two chamfers 252 and two notches 254. It should be noted that the one or more features 252, 254 may be omitted or the body 202 may include additional features based on an arrangement of components within the power module 100.

The body 202 includes a central portion 204. The central portion 204 defines a first end 206 and a second end 208 opposite the first end 206.

The body 202 also includes a first portion 210 integral with the central portion 204 and extending from the first end 206 of the central portion 204 along the longitudinal axis L1 of the body 202. The body 202 further includes a second portion 220 integral with the central portion 204 and extending from the second end 208 of the central portion 204 along the longitudinal axis L1 of the body 202.

Each of the central portion 204, the first portion 210, and the second portion 220 together define a top surface 230 of the body 202. Further, each of the central portion 204, the first portion 210, and the second portion 220 together define a cavity 232 of the body 202 that receives a portion of the fuse assembly 104 therein to remove and/or install the fuse assembly 104 from the power module 100. Specifically, the cavity 232 receives the housing 106 of the fuse assembly 104 therein.

The first portion 210 defines a first through-opening 212. In the illustrated examples of FIGS. 4 and 5, the first through-opening 212 is elliptical in shape. In other examples, the first through-opening 212 may have any other shape, such as a square shape, a circular shape, a rectangular shape, and the like, without limiting the scope of the present disclosure.

The first portion 210 includes a first bottom surface 214. As such the first through-opening 212 extends from the top surface 230 to the first bottom surface 214. The first portion 210 also includes a pair of first projections 216 extending from the first bottom surface 214 of the first portion 210 along the transverse axis T1 of the body 202. The pair of first projections 216 are spaced apart from each other along the lateral axis L2 of the body. The pair of first projections 216 define a first space 218 that is in alignment with the first through-opening 212. Each first projection 216 defines a curved inner surface 256. A shape and a curvature of the curved inner surface 256 is similar to a shape and a curvature of the rounded outer surface 124 of the first busbar 112. The first portion 210 defines a first inner surface 234 facing the cavity 232 of the body 202. Further, the first portion 210 includes the chamfer 252 at the top surface 230.

The second portion 220 defines a second through-opening 222. In the illustrated example of FIGS. 4 and 5, the second through-opening 222 is elliptical in shape. In other examples, the second through-opening 222 may have any other shape, such as a square shape, a circular shape, a rectangular shape, and the like, without limiting the scope of the present disclosure. The second portion 220 includes a second bottom surface 224. As such the second through-opening 222 extends from the top surface 230 to the second bottom surface 224. The second portion 220 also includes a pair of second projections 226 extending from the second bottom surface 224 of the second portion 220 along the transverse axis T1 of the body 202. The pair of second projections 226 are spaced apart from each other along the lateral axis L1 of the body 202. The pair of second projections 226 define a second space 228 that is in alignment with the second through-opening 222. Each second projection 226 defines a curved inner surface 258. A shape and a curvature of the curved inner surface 258 is similar to a shape and a curvature of the rounded outer surface 126 of the second busbar 118. The second portion 220 defines a second inner surface 236 facing the cavity 232 of the body 202. Further, the second portion 220 includes the chamfer 252 at the top surface 230.

The handheld tool 200 also includes a handle 250 coupled with the body 202 at the top surface 230 thereof. In an example, the handle 250 may be integral with the body 202. Alternatively, the handle 250 may be coupled with the body 202 by fasteners, welding, soldering, brazing, and the like. The body 202 and the handle 250 may be made of same material or different materials. In some examples, each of the body 202 and the handle 250 is made of a polymer. In an example, the body 202 and the handle 250 may be made of Nylon 66 material. In other examples, the body 202 and the handle 250 may be made of a ceramic material, an alloy, a composite, or any other material, without limiting the scope of the present disclosure.

Further, a personnel may use the handle 250 of the handheld tool 200 to carry the fuse assembly 104 to a desired location. The desired location may be a location within the power module 100 or a workstation. The workstation may include any location at which the fuse assembly 104 is assembled or disassembled from the handheld tool 200. The personnel may position the fuse assembly 104 at the desired location via the handheld tool 200.

Referring now to FIGS. 2, 4, and 5, the fuse assembly 104 is removably coupled with the body 202 of the handheld tool 200 via an interference fit. The fuse assembly 104 may be removably coupled with the body 202 of the handheld tool 200 via a snap fit, a push fit, a press fit, and the like, without limiting the scope of the present disclosure. The housing 106 of the fuse assembly 104 engages with each of the first inner surface 234 of the first portion 210 and the second inner surface 236 of the second portion 220 to removably couple the fuse assembly 104 with the body 202 of the handheld tool 200.

Further, when the fuse assembly 104 is received within the cavity 232 of the body 202, the first space 218 defined by the pair of first projections 216 receives the first busbar 112 of the fuse assembly 104 to removably couple the first busbar 112 with the first portion 210. Specifically, the first busbar 112 is removably coupled with the pair of first projections 216 via an interference fit. The first busbar 112 may be removably coupled with the pair of first projections 216 via a snap fit, a push fit, a press fit, and the like without limiting the scope of the present disclosure. When the first busbar 112 is removably coupled with the pair of first projections 216, the rounded outer surfaces 124 of the first busbar 112 engage with the curved inner surfaces 256 of the first projections 216 to retain the first busbar 112 within the first portion 210.

Furthermore, the first washer 114 is at least partially received within the first through-opening 212 defined by the first portion 210 to remove and/or install the fuse assembly 104 from the power module 100 (see FIG. 1). The pair of first fasteners 116 of the fuse assembly 104 are coupled with the first washer 114 and the first busbar 112 and are at least partially received within the first through-opening 212 defined by the first portion 210 to remove and/or install the fuse assembly 104 from the power module 100.

Referring now to FIGS. 3, 4, and 5, when the fuse assembly 104 is received within the cavity 232 of the body 202, the second space 228 defined by the pair of second projections 226 receives the second busbar 118 of the fuse assembly 104 to removably couple the second busbar 118 with the second portion 220. Specifically, the second busbar 118 is removably coupled with the pair of second projections 226 via an interference fit. The second busbar 118 may be removably coupled with the pair of second projections 226 via a snap fit, a push fit, a press fit, and the like, without limiting the scope of the present disclosure. When the second busbar 118 is removably coupled with the pair of second projections 226, the rounded outer surfaces 126 of the second busbar 118 engage with the curved inner surfaces 258 of the second projections 226 to retain the second busbar 118 within the second portion 220.

Furthermore, the second washer 120 of the fuse assembly 104 is at least partially received within the second through-opening 222 defined by the second portion 220 to remove and/or install the fuse assembly 104 from the power module 100. The pair of second fasteners 122 of the fuse assembly 104 is coupled with the second washer 120 and the second busbar 118 and are at least partially received within the second through-opening 222 defined by the second portion 210 to remove and/or install the fuse assembly 104 from the power module 100.

Referring to FIGS. 2 and 3, the personnel may use the handheld tool 200 to couple or remove the fuse assembly 104 from the power module 100 (see FIG. 1). In an example, in order to remove the fuse assembly 104 from the power module 100, the personnel may press the handheld tool 200 against the housing 106 of the fuse assembly 104 such that the housing 106 of the fuse assembly 104 engages with the cavity 232 of the body 202 of the handheld tool 200 via the interference fit. Further, when the fuse assembly 104 is received within the cavity 232 of the body 202 of the handheld tool 200, the first and second spaces 218, 228 receive the first and second busbars 112, 118, respectively, via the interference fit. Furthermore, when the fuse assembly 104 is received within the cavity 232 of the body 202 of the handheld tool 200, the first washer 114 and the pair of first fasteners 116 are received within the first through-opening 212. Further, the second washer 120 and the pair of second fasteners 122 are received within the second through-opening 222. Further, the personnel may use the handle 250 of the handheld tool 200 to carry the fuse assembly 104 to the workstation. The personnel may then disassemble the fuse assembly 104 from the handheld tool 200 at the workstation.

In another example, the personnel may use the handheld tool 200 to removably couple or install the fuse assembly 104 within the power module 100. In order to install the fuse assembly 104 within the power module 100, the personnel may press the handheld tool 200 against the housing 106 of the fuse assembly 104 such that the housing 106 of the fuse assembly 104 engages with the cavity 232 of the body 202 of the handheld tool 200 via the interference fit. Further, when the fuse assembly 104 is received within the cavity 232 of the body 202 of the handheld tool 200, the first and second spaces 218, 228 receive the first and second busbars 112, 118, respectively, via the interference fit. The personnel may insert the first washer 114, and the pair of first fasteners 116 within the first through-opening 212. Further, the personnel may insert the second washer 120 and the pair of second fasteners 122 within the second through-opening 222. The personnel may then use the handle 250 of the handheld tool 200 to carry the fuse assembly 104 to the power module 100 to install the fuse assembly 104 within the power module 100.

Thus, when the fuse assembly 104 is to be installed in the power module 100, the personnel may assemble the fuse assembly 104 with the handheld tool 200 at the workstation. Further, the personnel may carry the handheld tool 200 and the fuse assembly 104 to the power module 100. The personnel may then disassemble the fuse assembly 104 from the handheld tool 200 and install the fuse assembly 104 within the power module 100. It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the handheld tool 200 for the fuse assembly 104. The fuse assembly 104 is removably coupled with the body 202 of the handheld tool 200 via the interference fit. The handheld tool 200 may allow a quick coupling of the fuse assembly 104 to remove and/or install the fuse assembly 104 within the power module 100. The handheld tool 200 may reduce human effort and time required to remove and/or install the fuse assembly 104. Further, the handheld tool 200 may eliminate requirement of tools, such as a screwdriver, a wrench, and the like to remove and/or install the fuse assembly 104.

The handheld tool 200 includes the one or more features 252, 254. The one or more features 252, 254 includes the chamfer 252 and the notch 254. The one or more features 252, 254 may allow the handheld tool 200 to be used with a number of fuse assemblies and power modules to remove and/or install the fuse assemblies. Further, the handheld tool 200 is cost-effective as the handheld tool 200 has a simple design, is easy to manufacture, and does not require costly/complicated set-ups for manufacturing. Further, the handheld tool 200 may be used repeatedly to remove and/or install the number of fuse assemblies. Moreover, the handheld tool 200 may be used on a variety of the fuse assemblies and the power modules. It should be noted that one or more design features of the handheld tool 200 may vary as per a design of the fuse assembly 104 or the power module 100.

The body 202 and the handle 250 of the handheld tool 200 are made of the polymer that may increase flexibility and durability of the handheld tool 200. Further, the handle 250 may act as an insulator for the personnel and may not conduct electrical power therethrough. The handheld tool 200 may improve an efficiency of removing and/or installing the fuse assembly 104 within the power module 100. Further, the handle 250 may have an ergonomic design that may allow the personnel to easily and comfortably grasp the handheld tool 200.

Moreover, the handheld tool 200 may allow the personnel to quicky remove and/or install the fuse assembly 104 while wearing special protective gear like high-voltage protective equipment (HV PPE).

The handheld tool 200 may reduce an assembly time of the fuse assembly 104, may reduce fatigue, and may also reduce a downtime of the power module 100 by allowing easy installation and removal of the fuse assembly 104. Moreover, the handheld tool 200 eliminates a requirement of handling of the first washer 114, the second washer 120, the pair of first fasteners 116, and the pair of second fasteners 122 of the fuse assembly 104 within the power module 100, which may reduce the assembly time and efforts and may also reduce a possibility of dropping and/or misplacing of the first washer 114, the second washer 120, the pair of first fasteners 116, and the pair of second fasteners 122 within the power module 100.

Further, the handheld tool 200 may be used with existing fuse assemblies to remove and/or install the fuse assemblies with the power modules.

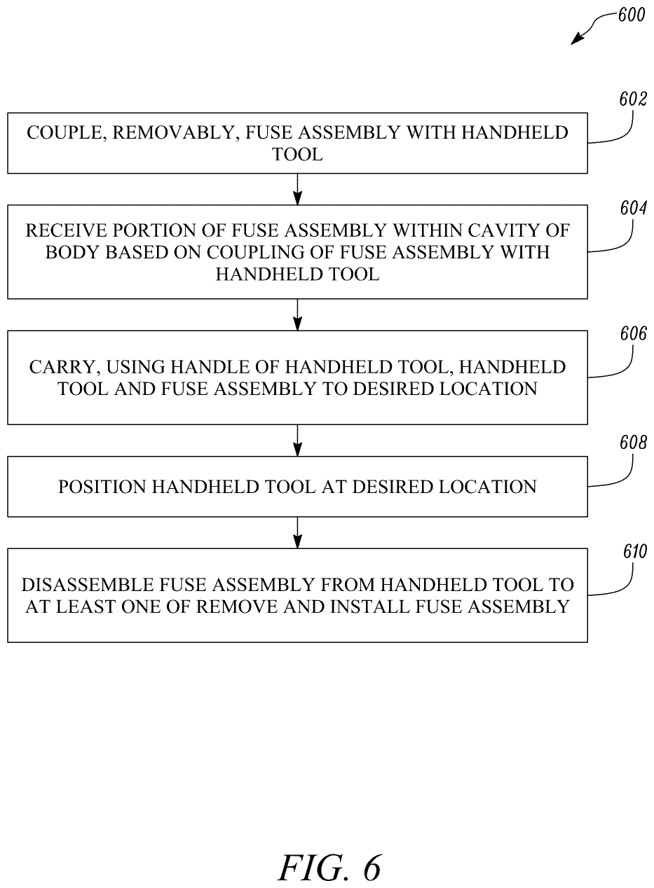

FIG. 6 is a flowchart for a method 600 of removing and/or installing the fuse assembly 104 in the power module 100. With reference to FIGS. 1 to 6, at step 602, the fuse assembly 104 is removably coupled with the handheld tool 200. The handheld tool 200 includes the body 202 extending along each of the longitudinal axis L1, the lateral axis L2, and the transverse axis T1. The body 202 includes the central portion 204 defining the first end 206 and the second end 208 opposite the first end 206. The body 202 also includes the first portion 210 integral with the central portion 204 and extending from the first end 206 of the central portion 204 along the longitudinal axis L1 of the body 202. The first portion 210 defines the first through-opening 212. The first portion 210 includes the first bottom surface 214 and the pair of first projections 216 extending from the first bottom surface 214 of the first portion 210 along the transverse axis T1 of the body 202. The pair of first projections 216 are spaced apart from each other along the lateral axis L1 of the body 202. The pair of first projections 216 define the first space that is in alignment with the first through-opening 212.

The body 202 further includes the second portion 220 integral with the central portion 204 and extending from the second end 208 of the central portion 204 along the longitudinal axis L1 of the body 202. The second portion 220 defines the second through-opening 222. The second portion 220 includes the second bottom surface 224 and the pair of second projections 226 extending from the second bottom surface 224 of the second portion 220 along the transverse axis T1 of the body 202. The pair of second projections 226 are spaced apart from each other along the lateral axis L2 of the body 202. The pair of second projections 226 define the second space 228 that is in alignment with the second through-opening 222.

Each of the central portion 204, the first portion 210, and the second portion 220 together define the top surface 230 of the body 202 and the cavity 232 of the body 202. The handheld tool 200 also includes the handle 250 coupled with the body 202 at the top surface 230 thereof.

The step 602 further includes removably coupling the body 202 of the handheld tool 200 with the fuse assembly 104 via the interference fit.

The first portion 210 also defines the first inner surface 234 facing the cavity 232 of the body 202. The second portion 220 also defines the second inner surface 236 facing the cavity 232 of the body 202. Further, the housing 106 of the fuse assembly 104 is engaged with each of the first inner surface 234 of the first portion 210 and the second inner surface 236 of the second portion 220. The step 602 further includes engaging the housing 106 of the fuse assembly 104 with each of the first inner surface 234 of the first portion 210 and the second inner surface 236 of the second portion 220.

The step 602 further includes receiving the first busbar 112 of the fuse assembly 104 within the first space 218 defined by the pair of first projections 216. The step 602 further includes removably coupling the first busbar 112 with the first portion 210 based on the receipt of the first busbar 112 within the first space 218.

The step 602 further includes at least partially receiving, the first washer 114 of the fuse assembly 104 within the first through-opening 212 defined by the first portion 210. The step 602 further includes coupling the pair of first fasteners 116 of the fuse assembly 104 with the first washer 114 and the first busbar 112, such that the pair of first fasteners 116 are at least partially received within the first space 218 defined by the first portion 210.

The step 602 further includes receiving, the second busbar 118 of the fuse assembly 104 within the second space 228 defined by the pair of second projections 226. The step 602 further includes removably coupling the second busbar 118 with the second portion 220 based on the receipt of the second busbar 118 within the second space 228.

The step 602 further includes at least partially receiving, the second washer 120 of the fuse assembly 104 within the second through-opening 222 defined by the second portion 220. The step 602 further includes coupling the pair of second fasteners 122 of the fuse assembly 104 with the second washer 120 and the second busbar 118, such that the pair of second fasteners 122 are at least partially received within the second space 228 defined by the second portion 220.

At step 604, the portion of the fuse assembly 104 is received within the cavity 232 of the body 202 based on the coupling of the fuse assembly 104 with the handheld tool 200.

At step 606, the handheld tool 200 and the fuse assembly 104 are carried to the desired location using the handle 250 of the handheld tool 200. The desired location includes the location within the power module 100 or the workstation.

At step 608, the handheld tool 200 is positioned at the desired location.

At step 610, the fuse assembly 104 is disassembled from the handheld tool 200 to remove and/or install the fuse assembly 104.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

1. A handheld tool for a fuse assembly, the handheld tool comprising:
a body extending along each of a longitudinal axis, a lateral axis, and a transverse axis, wherein the body includes:
a central portion defining a first end and a second end opposite the first end;
a first portion integral with the central portion and extending from the first end of the central portion along the longitudinal axis of the body, wherein the first portion defines a first through-opening, wherein the first portion includes a first bottom surface and a pair of first projections extending from the first bottom surface of the first portion along the transverse axis of the body, wherein the pair of first projections are spaced apart from each other along the lateral axis of the body, and wherein the pair of first projections define a first space that is in alignment with the first through-opening; and
a second portion integral with the central portion and extending from the second end of the central portion along the longitudinal axis of the body, wherein the second portion defines a second through-opening, wherein the second portion includes a second bottom surface and a pair of second projections extending from the second bottom surface of the second portion along the transverse axis of the body, wherein the pair of second projections are spaced apart from each other along the lateral axis of the body, wherein the pair of second projections define a second space that is in alignment with the second through-opening, and wherein each of the central portion, the first portion, and the second portion together define a top surface of the body and a cavity of the body that is adapted to receive a portion of the fuse assembly therein to at least one of remove and install the fuse assembly from a power module; and
a handle coupled with the body at the top surface thereof.

2. The handheld tool of claim 1, wherein the fuse assembly is removably coupled with the body of the handheld tool via an interference fit.

3. The handheld tool of claim 1, wherein the first portion defines a first inner surface facing the cavity of the body, wherein the second portion defines a second inner surface facing the cavity of the body, and wherein a housing of the fuse assembly is adapted to engage with each of the first inner surface of the first portion and the second inner surface of the second portion to removably couple the fuse assembly with the body of the handheld tool.

4. The handheld tool of claim 1, wherein, when the fuse assembly is received within the cavity of the body, the first space defined by the pair of first projections is adapted to receive a first busbar of the fuse assembly to removably couple the first busbar with the first portion.

5. The handheld tool of claim 4, wherein the first busbar is removably coupled with the pair of first projections via an interference fit.

6. The handheld tool of claim 4, wherein a first washer of the fuse assembly is adapted to be at least partially received within the first through-opening defined by the first portion to at least one of remove and install the fuse assembly from the power module.

7. The handheld tool of claim 6, wherein a pair of first fasteners of the fuse assembly are adapted to be coupled with the first washer and the first busbar and is at least partially received within the first through-opening defined by the first portion to at least one of remove and install the fuse assembly from the power module.

8. The handheld tool of claim 1, wherein, when the fuse assembly is received within the cavity of the body, the second space defined by the pair of second projections is adapted to receive a second busbar of the fuse assembly to removably couple the second busbar with the second portion.

9. The handheld tool of claim 8, wherein the second busbar is removably coupled with the pair of second projections via an interference fit.

10. The handheld tool of claim 8, wherein a second washer of the fuse assembly is adapted to be at least partially received within the second through-opening defined by the second portion to at least one of remove and install the fuse assembly from the power module.

11. The handheld tool of claim 10, wherein a pair of second fasteners of the fuse assembly is adapted to be coupled with the second washer and the second busbar and is at least partially received within the second through-opening defined by the second portion to at least one of remove and install the fuse assembly from the power module.

12. The handheld tool of claim 1, wherein each of the body and the handle is made of a polymer.

13. The handheld tool of claim 1, wherein the body further includes one or more features to allow positioning of the handheld tool within the power module or removal of the handheld tool from the power module, and wherein the one or more features include at least one of a chamfer and a notch.

14. A method of at least one of removing and installing a fuse assembly in a power module, the method comprising:
coupling, removably, the fuse assembly with a handheld tool, wherein the handheld tool includes:
a body extending along each of a longitudinal axis, a lateral axis, and a transverse axis, wherein the body includes:
a central portion defining a first end and a second end opposite the first end;
a first portion integral with the central portion and extending from the first end of the central portion along the longitudinal axis of the body, wherein the first portion defines a first through-opening, wherein the first portion includes a first bottom surface and a pair of first projections extending from the first bottom surface of the first portion along the transverse axis of the body, wherein the pair of first projections are spaced apart from each other along the lateral axis of the body, and wherein the pair of first projections define a first space that is in alignment with the first through-opening; and
a second portion integral with the central portion and extending from the second end of the central portion along the longitudinal axis of the body, wherein the second portion defines a second through-opening, wherein the second portion includes a second bottom surface and a pair of second projections extending from the second bottom surface of the second portion along the transverse axis of the body, wherein the pair of second projections are spaced apart from each other along the lateral axis of the body, wherein the pair of second projections define a second space that is in alignment with the second through-opening, and wherein each of the central portion, the first portion, and the second portion together define a top surface of the body and a cavity of the body; and
a handle coupled with the body at the top surface thereof;
receiving a portion of the fuse assembly within the cavity of the body based on the coupling of the fuse assembly with the handheld tool;
carrying, using the handle of the handheld tool, the handheld tool and the fuse assembly to a desired location, wherein the desired location includes a location within the power module or a workstation;
positioning the handheld tool at the desired location; and
disassembling the fuse assembly from the handheld tool to at least one of remove and install the fuse assembly.

15. The method of claim 14, wherein the step of coupling the fuse assembly with the handheld tool further includes removably coupling the body of the handheld tool with the fuse assembly via an interference fit.

16. The method of claim 14, wherein the first portion defines a first inner surface facing the cavity of the body, wherein the second portion defines a second inner surface facing the cavity of the body, and wherein the step of coupling the fuse assembly with the handheld tool further includes engaging a housing of the fuse assembly with each of the first inner surface of the first portion and the second inner surface of the second portion.

17. The method of claim 14, wherein the step of coupling, removably, the fuse assembly with the handheld tool further includes:
receiving a first busbar of the fuse assembly within the first space defined by the pair of first projections; and
coupling, removably, the first busbar with the first portion based on a receipt of the first busbar within the first space.

18. The method of claim 17, wherein the step of coupling, removably, the fuse assembly with the handheld tool further includes:
at least partially receiving a first washer of the fuse assembly within the first through-opening defined by the first portion; and
coupling a pair of first fasteners of the fuse assembly with the first washer and the first busbar, such that the pair of first fasteners are at least partially received within the first space defined by the first portion.

19. The method of claim 14, wherein the step of coupling, removably, the fuse assembly with the handheld tool further includes:
receiving a second busbar of the fuse assembly within the second space defined by the pair of second projections; and
coupling, removably, the second busbar with the second portion based on a receipt of the second busbar within the second space.

20. The method of claim 19, wherein the step of coupling, removably, the fuse assembly with the handheld tool further includes:
at least partially receiving a second washer of the fuse assembly within the second through-opening defined by the second portion; and
coupling a pair of second fasteners of the fuse assembly with the second washer and the second busbar, such that the pair of second fasteners are at least partially received within the second space defined by the second portion.
